(19) United States
(12) Patent Application Publication
(10) Pub. No.: US 2008/0060025 A1
(43) Pub. Date: Mar. 6, 2008

(54) Car theater video and audio entertainment system

(76) Inventor: Ying-Chung Chen, Taipei Hsien (TW)

Correspondence Address: Troxell Law Office Pllc, Suite 1404, 5205 Leesburg Pike, Falls Church, VA, 22041, US

(21) Appl. No.: 11/543,975

(22) Filed: Oct. 6, 2006

(30) Foreign Application Priority Data
Aug. 30, 2006 (TW) 095215351

(51) Int. Cl. H04N 7/18

(52) U.S. Cl. 725/74; 725/75

(57) ABSTRACT

A car theater video and audio entertainment system is provided with a host box. An interior of the host box is installed with a memory, a wireless signal receiving antenna, a booster, and plural sets of video and audio multiplexers. An input end of the host box is connected to a VCD/DVD player, and an output end of the host box is connected to a plurality of display screens and a plurality of control panels. The control panel is provided with more than two insertion holes for receiving a game controller, an earphone, or a pair of head-mounted virtual glasses. The memory stores a lot of video files, music files, image files, and video game software. By using the control panel to control the host box, each user can choose a channel according to his or her preferences, without interfering with or being interfered by other users.

### BACKGROUND OF THE INVENTION

(a) Field of the Invention

The present invention relates to a car theater video and audio entertainment system, and more particularly to a car theater video and audio entertainment system which can provide an individual to choose a channel for viewing according to his or her preferences, and is applied to a vehicle ridden by many passengers, such as an automobile, a tour bus, a train, an airplane, or a ship, to allow many persons to use different channels for entertainment at the same time.

(b) Description of the Prior Art

There are many kinds of mass transportation vehicles, and among which a tour bus is the most popular one. For example, a tour bus drives passengers from place A to place B, and needs to spend about 5 hours; therefore, in order to prevent the on-board passengers from being bored during the trip, the tour bus will be normally provided with a plurality of display screens to play TV programs which can be viewed by the passengers.

In the aforementioned conventional in-car video and audio entertainment player structure, signal wires which connect the multiple display screens are pulled to a place next to a driver's seat to be connected with a video cassette recorder located nearby the driver's seat, and a film tape or a CD (Compact Disk) is put into the video cassette recorder for playing by the driver or a tour guide, such that the content of the film can be transmitted through the signal wires to the multiple display screens. Although this method can provide the on-board passengers with another kind of entertainment, the passengers cannot choose freely programs that they would like to see, and can only watch the programs passively. If there are not enough amount of the display screens installed on the vehicle, the passengers can only watch the display screens which are closest to them, and if the display screens are too far away or are not provided with a correct angle, then the passengers will not be able to clearly watch the film, which are the shortcomings of conventional technique.

Accordingly, how to provide a video and audio collection box which allows viewers to choose freely their favorite programs is a motivation of creation of the present invention.

### SUMMARY OF THE INVENTION

The primary object of present invention is to provide a car theater video and audio entertainment system which allows viewers to choose freely their favorite video or audio programs according to an individual's preferences, instead of watching a single program at the same time.

Another object of the present invention is to provide a car theater video and audio entertainment system which may include a wireless TV, a player, and/or a memory which stores the video and audio file such as an AVI (Audio Video Interleaved) file, an MPG1 (Motion Picture Experts Group Layer 1) file, an MP2 (Motion Picture Experts Group Layer 2) file, an MP3 (Motion Picture Experts Group Layer 3) file, an MP4 (Motion Picture Experts Group Layer 4) file, and video game software.

Accordingly, a car theater video and audio entertainment system of the present invention includes a host box; an interior provided with a memory, a wireless signal receiving antenna, a booster, and a plurality of audio and video multiplexers; and an exterior provided with an input end for connecting with a VCD (Video Compact Disc)/DVD (Digital Video Disc) player, and an output end for connecting with a plurality of display screens and a plurality of control panels with more than two insertion holes for receiving an insertion of a game controller and an earphone. The memory stores a plurality of video files, music files, image files, and video game software, while the host box is controlled through the control panels, such that each user can choose his or her favorite channels according to personal preferences, without interfering with other users.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a perspective view of an embodient of the present invention.

FIG. 2 shows a circuit block diagram of an embodient of the present invention.

FIG. 3 shows a schematic view of a complete assembly of an embodient of the present invention.

FIG. 4 shows a schematic view of an embodient of the present invention in a use status.

### DETAILED DESCRIPTION OF THE PREFERRED EMBODIMENTS

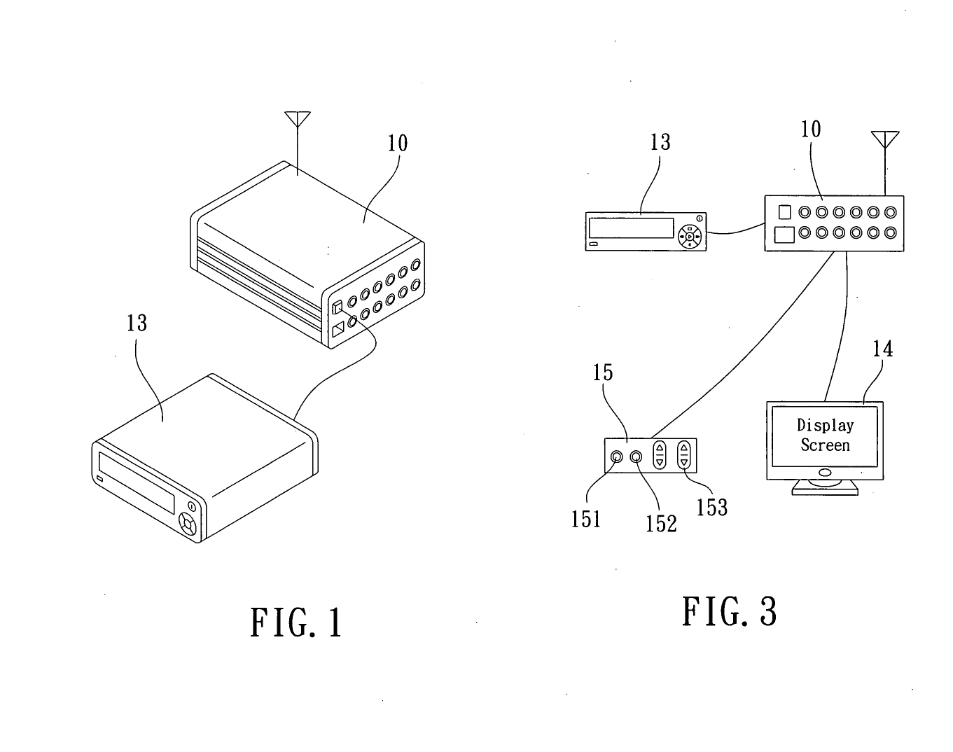

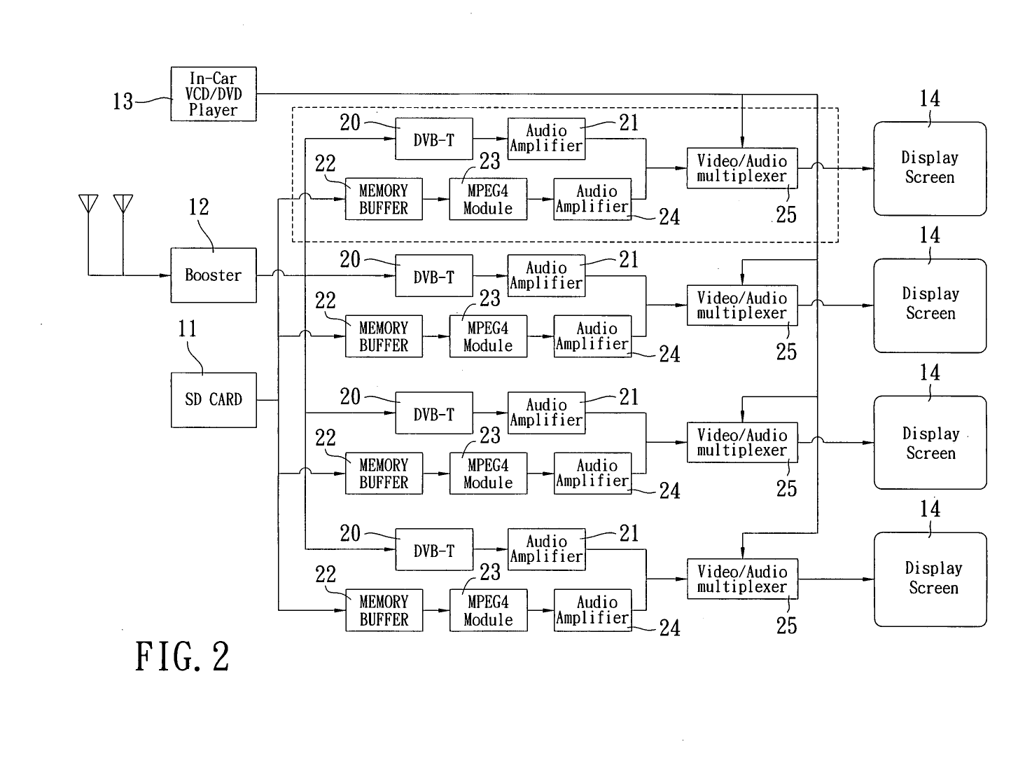

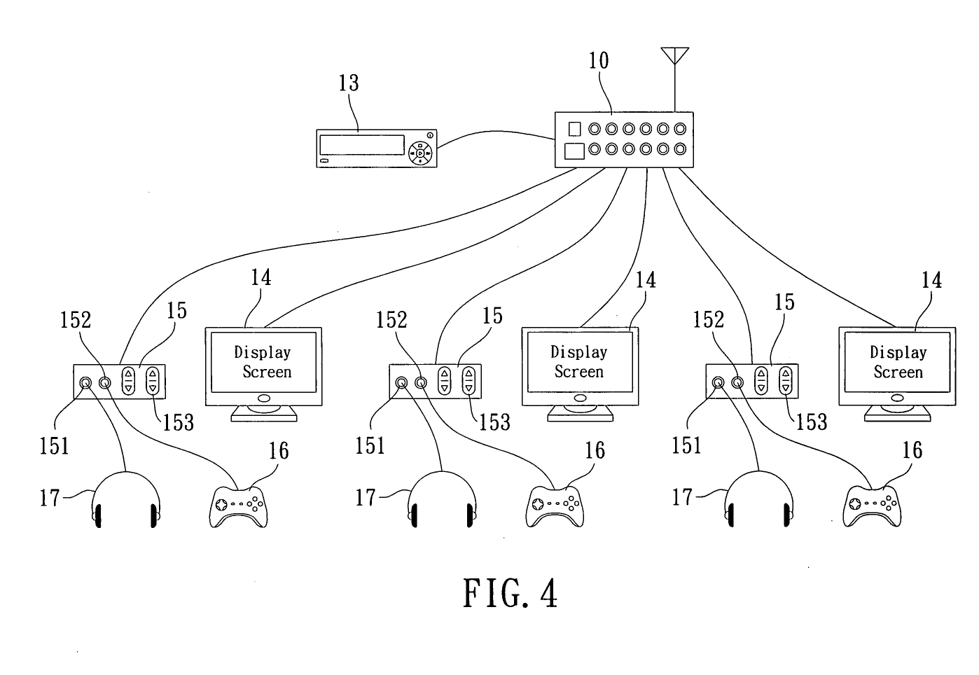

Referring to FIGS. 1 to 3, a car theater video and audio entertainment system of the present invention comprises primarily a host box 10 which is provided with a wireless signal receiving antenna. An interior of the host box 10 is installed with a memory [SD card (Secure Digital card)] 11, a booster 12 which is connected to the wireless signal receiving antenna, plural sets of DVB-T (Digital Video Broadcasting-Terrestrial) digital TV signals 20, plural sets of a first audio amplifier 21, plural sets of memory buffers 22, an MPEG4 (Motion Picture Experts Group Layer 4) module 23, plural sets of a second audio amplifier 24, and plural sets of video and audio multiplexers 25. The memory (SD card) 11 stores an extremely large amount of video files, music files, image files, and TV game software. An input end at an exterior of the host box is connected to a VCD/DVD player 13, and an output end at the exterior of host box is connected to a plurality of display screens 14 and a plurality of control panels 15 which are provided with more than two insertion holes 151, 152 for receiving an insertion of a game controller 16, an earphone 17 (as shown in FIG. 4), or a pair of head-mounted virtual glasses (not shown in the drawings).

Through the wireless signal receiving antenna and the booster 12, the host box 10 can receive the DVB-T digital TV signals at 6 MHz (Taiwan area), or 7 or 8 MHz (European area), and the plural control panels 15 are installed with function switching keys 153, allowing the plural display screens 14 to play the signals chosen by the host box through a pressing and switching of the function switching keys 153. As the memory 11 can store the video and audio signals, such as the DVB-T digital TV signals, signals of the VCD/DVD player 13, AVI signals, MPG1 signals, MP2 signals, MP3 signals, and MP4 signals, and the earphone 17 is inserted into the insertion hole 151 of the control panel 15, these signals or programs can be viewed by using the earphone 17 and the display screen 14. Or, the head-mounted virtual glasses (not shown in the drawings) can be directly inserted, and the content of film can be watched from the glasses, and the sound can be listened from an earphone which is attached to the glasses, thereby achieving a function of being more convenient to watch the images and listen to the sound.

Referring to FIG. 4, it shows an embodiment of the present invention being assembled on a tour bus. The host box 10 is installed next to a driver's seat; the nearby VCD/DVD player 13 is connected to an input end of the host box 10; the display screens 14 are installed on a head cushion at a seat back of each chair; the control panels 15 are installed at an armrest of each chair; and the signal wires of each display screen 14 and each control panel 15 are pulled to an output end of the host box 10 for connection. In addition, each chair is provided with the game controller 16, the earphone 17, and the head-mounted virtual glasses (not shown in the drawing). When the tour bus carries a plurality of passengers, each passenger can press down the function switching keys 153 by himself or herself through the control panel 15 on the armrest of chair, to choose the video and audio services provided by the host box 10. For example, if a first passenger (A) would like to watch a movie X, he or she can choose to use the VCD/DVD player 13, the memory 11, or the digital TV of Taiwanese or European wireless signals to play the movie X, through the control panel 15. Following that, the earphone 17 can be inserted into the insertion hole 151 of control panel 15, and then the movie X can be watched. Or, the passenger can directly insert the head-mounted virtual glasses (not shown in the drawing) to enjoy the video and audio effect. If a second passenger (B) would not like to watch the movie X, but to enjoy music, he or she can use the control panel 15 to switch to an MP3 music Y in the memory 11, to enjoy the music directly through the earphone 17. If a third passenger (C) would not like to watch the movie X nor to listen to the MP3 music Y, he or she can insert the game controller 16 into the insertion hole 152 of control panel 15, and switch the function of control panel 15 to a game area in the memory 11, to play the game through the game controller 16. After each passenger has chosen the different function, they can all use the earphone 17 without interfering with each other. As the host box 10 is installed with the memory (SD card) 11 to provide an extremely large space for storing the information media, when a fourth passenger (D) would like to watch the movie X after a period of time, and uses the control panel 15 to choose to play the movie X stored in the memory 11 at a first time, the movie X to be chosen can be played starting from its title, without being affected by that the first passenger (A) has already bee watching the same movie X. Accordingly, the host box 10 of the present invention can integrate a plurality of different video and audio signals, and sound and TV game controller software, to achieve an effect of outputting independently, such that when the present invention is applied to a vehicle ridden by many persons, such as an automobile, a tour bus, a train, an airplane, or a ship, the users can freely choose their preferred audio and video programs and the game interfaces.

Accordingly, the present invention is provided with the following advantages:
1. The DVB-T digital TV signals can be received.
2. The AVI, MPG1, MP2, and MP4 video files stored in the memory card can be played.
3. The MP3 music stored in the memory card can be played.
4. The input of AV (Audio/Video) and stereophonic sound can be received.
5. The DVB-T digital TV can be chosen independently for watching.
6. The film or music stored in the memory card can be independently chosen for playing.
7. The DVD, DVB-T, or memory card can be switched for playing.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A car theater video and audio entertainment system comprising a host box, an interior of which is provided with a memory (SD card), a wireless signal receiving antenna, a booster, plural sets of video and audio multiplexers; an input end of which is connected to a VCD (Video Compact Disc) or DVD (Digital Video Disc) player, and an output end of which is connected with a plurality of display screens and a plurality of control panels; the control panel is provided with more than two insertion holes for receiving a TV game controller, an earphone, or a pair of head-mounted virtual glasses.

2. The car theater video and audio entertainment system according to claim 1, wherein the interior of the host box is provided with the memory (SD card), the wireless signal receiving antenna, the booster, plural sets of DVB-T (Digital Video Broadcasting-Terrestrial) digital TV signals, plural sets of a first audio amplifier, plural sets of memory buffers, plural sets of MPEG4 (Motion Picture Experts Group Layer 4) modules, plural sets of a second audio amplifier, and plural sets of video and audio multiplexers.

3. The car theater video and audio entertainment system according to claim 1, wherein the memory (SD card) stores a plurality of video files, music files, image files, and video game software.
